(19) United States
(12) Patent Application Publication
(10) Pub. No.: US 2023/0313785 A1
(43) Pub. Date: Oct. 5, 2023

(54) SYSTEM AND METHOD FOR INCREASING THE KINETIC ENERGY OF A DIRECTIONAL PLASMA FLOW

(71) Applicant: Randell L. MILLS, Coatesville, PA (US)

(72) Inventor: Randell L. MILLS, Coatesville, PA (US)

(21) Appl. No.: 18/021,138

(22) PCT Filed: Jul. 30, 2021
(86) PCT No.: PCT/US2021/044070

§ 371 Date: Feb. 13, 2023

Related U.S. Application Data
(60) Provisional application No. 63/067,191, filed on Aug. 18, 2020.

(51) Int. Cl. F03H 1/00

(52) U.S. Cl. CPC F03H 1/0093; F03H 1/0081

(57) ABSTRACT

A propulsion system providing at least one of propulsion and lift comprising a source of a molecular beam or jet, a plasma generator coupled to the source, a plasma chamber coupled to the source and to the plasma generator to maintain a hydrogen plasma comprising free electrons and H+ ions, a microwave generator, a horn antenna, and a negatively charged, repulsive electrode to repel received electrons that have absorbed microwaves in a directional manner and gained reactionless kinetic energy in a directional manner.

### RELATED APPLICATION

This application claims the benefit of U.S. provisional patent application Ser. No. 63/067,191, entitled SYSTEM AND METHOD FOR GENERATING AND CONTROLLING IONIZED MOLECULAR ENERGY, filed Aug. 18, 2020, the contents of which are herein incorporated by reference.

### FIELD OF THE INVENTION

The present invention is directed to a propulsion system, and is more specifically directed to a propulsion system using photon energy.

### SUMMARY OF THE INVENTION

The nature of absolute space for the proper time and mass/energy of a fundamental particle such as a free electron and the constant maximum speed of light give rise to a reactionless means of propulsion involving conservation of photon energy absorbed by a free lepton such as a free electron. Specifically, conservation laws of a fundamental particle such as a free electron during photon absorption results in the increase in inertial parameters of inertial momentum and mass/energy corresponding to kinetic energy relative to absolute space with no reaction of a third body reaction partner in the exchange. In an embodiment, radiation such as microwave radiation is absorbed by free electrons which gain kinetic energy along a preferential axis and may drag positive ions and a plasma flow. The electrons or plasma are incident to a repulsive electrostatic field or rigid piston to transduce the kinetic energy into propulsion energy.

In an embodiment of the propulsion system of the present invention (herein called a space drive), an incident photon increases the kinetic energy of an electron by ½ of the photon energy given by ℏω wherein ℏ is Planck's constant bar and ω is the photon angular frequency. The kinetic energy may be harnessed for propulsion or lift by directing the kinetic energized electrons toward a repulsive field means such as a negatively charged electrode whereby the repulsive forces are transferred to the structure supporting the electrode to cause translation or lift. The classical theory regarding the nature of the photon and free electron that give rise to the reactionless force exploited herein as the mechanism of the space drive of the present invention is given in the R. Mills The Grand Unified Theory of Classical Physics January 2020 Edition, http://brilliantlightpower.com/book-download-and-streaming/, such as Chapters 3 and 4 forming part of the current specification.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention.

FIGS. 1A-1C illustrate portions of the space drive of the present invention.

FIG. 2 is a schematic representation of a free electron according to the teachings of the present invention.

FIG. 3 is a schematic representation of a trihydrogen ion according to the teachings of the present invention

### DETAILED DESCRIPTION

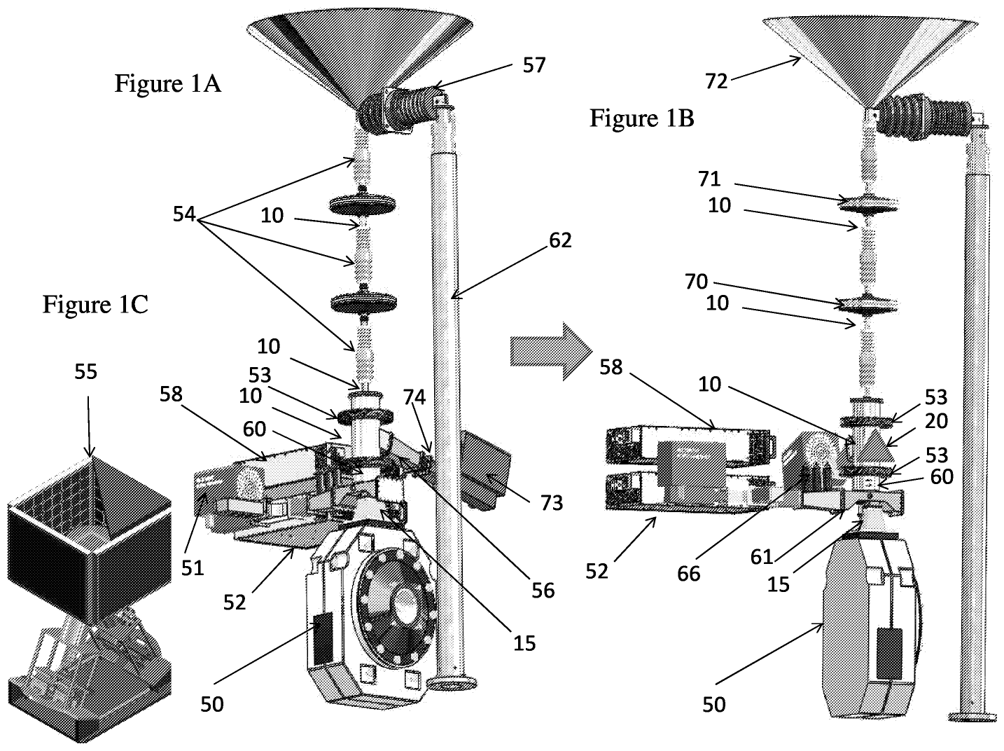

In an embodiment shown in FIGS. 1-3, the space drive of the present invention comprises a directional beam of electrons or a directional flow of a source of electrons, such as a gas beam, examples of which include a hydrogen gas molecular beam. The electron beam or flow and associated gas beam or flow may be axial or linear. The molecular beam may be formed for example by expansion of high-pressure gas through a jet nozzle. The molecular beam may comprise a supersonic molecular beam or jet. The space drive further comprises an ionization chamber that may create a direction flow of electrons from the molecular beam source. The ionization chamber may comprise a discharge chamber comprising a power source and a plasma generator such as at least one of (i) a microwave plasma system such as one comprising a microwave generator, wave guide, tuning stubs, and at least one antenna such as a surfaguide plasma system, (ii) an inductively or capacitive coupled RF plasma generator such as one comprising an antenna coil or electrodes, and (iii) a glow discharge system comprising a power supply and at least two electrodes that are biased by the power supply. In an embodiment, the discharge chamber forms a flow or beam of free electrons. The electron beam may further comprise a flow or beam of co-propagating position ions. In another embodiment, the space drive comprises an electron beam emitted from an electron gun. The space drive may further comprise a source of photons that are absorbed by the electrons of the electron beam or the flowing or propagating electrons. The photon absorption may increase the electron kinetic energy of the electrons in their initial direction of travel. The photon source may comprise a laser in any frequency range such as infrared to X-ray. Alternatively, the photon source may comprise a microwave generator such as one with a horn antenna. The antenna may polarize the microwaves. In an exemplary embodiment, the microwaves may comprise linearly polarized photons with the electric field parallel to the plane of the free electrons. The electrons may further drag positive ions of a plasma such that the kinetic energy inventory of the resulting flow comprises electron and positive ion kinetic energy and momentum.

The space drive may further comprise a drift or plasma channel 10 and a repulsive field means or a braking means or element to receive the kinetic energy inventory by braking at least one of the electron or plasma flow and the pressure due to the flow. The braking element may comprise a rigid piston such as a closed chamber at the end of the electron drift channel 10 or plasma channel 10. The braking element, such as the rigid piston, may be rigidly attached to an object to be propelled. The energetic electrons, energized by selective acceleration in the initial direction of motion by photon absorption, may flow into the drift channel 10 and become incident on the repulsive field means. The repulsive field means may comprise a source of a repulsive electric field. The electric field of the repulsive field means may apply a repulsive force to the propagation of the electrons such that the electrons lose kinetic energy by transferring the energy to the repulsive field means or the braking element. The repulsive field means may comprise at least one negatively charged electrode. The kinetic energized electrons may be directed towards the repulsive field means such as a negatively charged electrode and transfer the kinetic energy to the electrode. This process is called electron braking. The electron kinetic energy may be harnessed for propulsion or lift. The repulsive forces of electron braking may be transferred to a structure supporting the electrode to cause translation or lift of a craft rigidly connected to the structural support.

The energetic electrons may drag the corresponding molecular ions, such as H₃⁺ ions. The electron-ion pairs may transfer kinetic energy to a collector by at least one of pressure-volume work and electron breaking. The electrons and hydrogen ions may recombine following the electrons working on the repulsive field means. The space drive may further comprise a pump to recycle the gas formed by recombination. In another embodiment comprising an electron beam, the electrons may be de-energized by transferring kinetic energy to the repulsive field means and may be collected in a beam dump and recirculated.

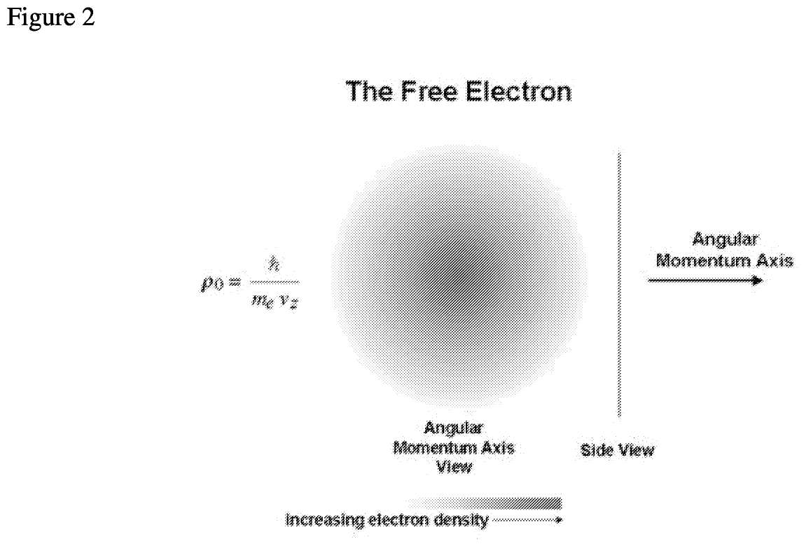

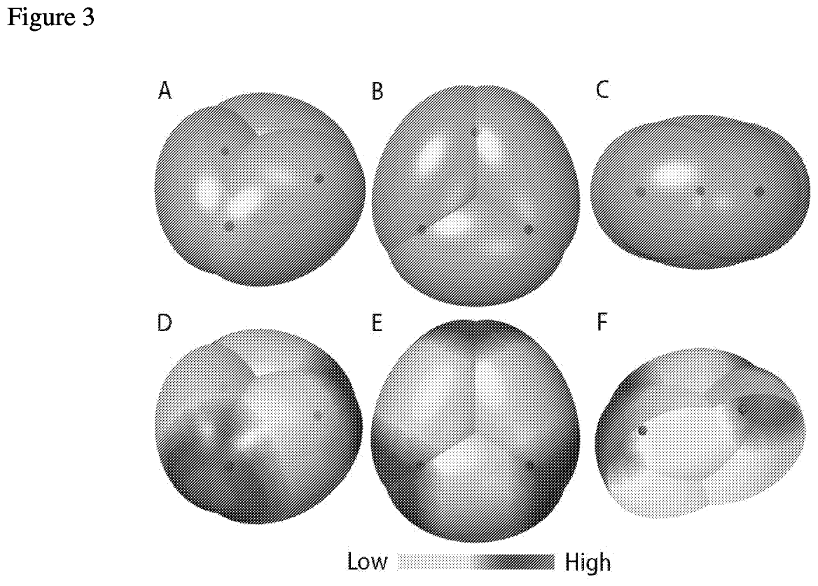

In the exemplary embodiment shown in FIGS. 1A-1C, the space drive comprises a source of a molecular beam or jet, a surfaguide plasma generator and a plasma chamber to maintain a hydrogen plasma comprising free electrons (FIG. 2) and H₃⁺ ions (FIG. 3), a microwave generator, a horn antenna, and at least one electrode. At least one electrode may comprise a negatively charged, repulsive electrode to repel received electrons that have absorbed microwaves in a directional manner. At least one electrode may be negatively charged to repel the electrons. The kinetic energy of the electrons may be transferred to the repulsive electrode and cause lift to structural elements supporting the electrode. At least one electrode may comprise openings for electrons to flow through. At least one electrode may comprise a metal mesh grid electrode. The electrodes may be parallel. The electrode may comprise parallel plates. At least one of the parallel plate electrodes may comprise preformations for electrons to pass such as a parallel plate metal mesh grid electrode. In an embodiment, at least two electrodes may comprise a capacitor wherein the gas of the molecular beam may serve as the dielectric, or the dielectric may be absent. The space drive may comprise a plurality of units oriented along different axes to achieve drive in the corresponding selected direction. Alternatively, the space drive may comprise at least one space drive system with a reorientation means to cause the corresponding drive system to tilt in a selected direction to achieve drive in that direction.

Specifically, as shown in FIGS. 1A-1C, the space drive may be powered by a SunCell® 55 power source, such as one comprising a magnetohydrodynamic or photovoltaic converter that can reject excess heat through a radiative heat exchanger. An exemplary SunCell® power source comprises a power system that generates at least one of electrical energy and thermal energy comprising at least one vessel capable of a maintaining a pressure below atmospheric; reactants capable of undergoing a reaction that produces enough energy to form a plasma in the vessel comprising (a) a mixture of hydrogen gas and oxygen gas, and/or water vapor, and/or a mixture of hydrogen gas and water vapor, and (b) a molten metal; a mass flow controller to control the flow rate of at least one reactant into the vessel; a vacuum pump to maintain the pressure in the vessel below atmospheric pressure when one or more reactants are flowing into the vessel; a molten metal injector system comprising at least one reservoir that contains some of the molten metal such as molten tin, a molten metal pump system (e.g., one or more electromagnetic pumps) configured to deliver the molten metal in the reservoir and through an injector tube to provide a molten metal stream, and at least one non-injector molten metal reservoir for receiving the molten metal stream; at least one ignition system comprising a source of electrical power or ignition current to supply electrical power to the at least one stream of molten metal to ignite the reaction when the hydrogen gas and/or oxygen gas and/or water vapor are flowing into the vessel; and a reactant supply system to replenish reactants that are consumed in the reaction; a power converter or output system to convert a portion of the energy produced from the reaction (e.g., light and/or thermal output from the plasma) to electrical power and/or thermal power. The SunCell® power systems may comprise those of the present disclosure or as set forth in U.S. patent applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed PCT Jan. 10, 2014; Photovoltaic Power Generation Systems and Methods Regarding Same, PCT/US14/32584 filed PCT Apr. 1, 2014; Electrical Power Generation Systems and Methods Regarding Same, PCT/US2015/033165 filed PCT May 29, 2015; Ultraviolet Electrical Generation System Methods Regarding Same, PCT/US2015/065826 filed PCT Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed PCT Dec. 7, 2017; Thermophotovoltaic Electrical Power Generator, PCT/US2017/013972 filed PCT Jan. 18, 2017; Extreme and Deep Ultraviolet Photovoltaic Cell, PCT/US2018/012635 filed PCT Jan. 5, 2018; Magnetohydrodynamic Electric Power Generator, PCT/US18/17765 filed PCT Feb. 12, 2018; Magnetohydrodynamic Electric Power Generator, PCT/US2018/034842 filed PCT May 29, 2018; Magnetohydrodynamic Electric Power Generator, PCT/IB2018/059646 filed PCT Dec. 5, 2018; Magnetohydrodynamic Electric Power Generator, PCT/IB2020/050360 filed PCT Jan. 16, 2020; Magnetohydrodynamic Hydrogen Electric Power Generator, PCT/US21/17148 filed Feb. 8, 1921; and the US Provisional applications INFRARED LIGHT RECYCLING THERMOPHOTOVOLTAIC HYDROGEN ELECTRICAL POWER GENERATOR:

| Application No | Filed Date |
|---|---|
| 63/158,349 | 20210308 |
| 63/167,110 | 20210328 |
| 63/176,054 | 20210416 |
| 63/214,236 | 20210623 |

all herein incorporated by reference in their entirety.

The space drive may comprise a molecular beam source 50, a plasma cavity 60, a plasma channel 10, and a braking element and transduce kinetic flow of at least one of electrons and plasma for (i) the propagation of the molecular beam such as a supersonic hydrogen gas beam from the source 50, (ii) the formation of plasma comprising free electrons and ions from the molecular beam, and (iii) the propagation free electrons and ions that are irradiated and absorb electromagnetic radiation during the propagation to the braking element and transduce kinetic flow of at least one of electrons and plasma. The molecular beam source 50 may comprise a source of gas such a hydrogen gas, a gas pump to achieve high gas pressure, a jet nozzle, values, pressure and flow sensors, a control system, and a gas recirculation system to recover the gas once it has served to produce the desired work of the space drive. The gas recirculation system may comprise at least one gas pump, gas lines, flow and pressure sensors, and a controller. The molecular beam may be ionized in the plasma cavity 60. The cavity 60 may comprise a plasma generator such as a surfaguide plasma generator that may comprise a power supply 52, a microwave generator 51, a waveguide 61, and tuning stubs 66 to match the impedance of the load and the plasma cavity to the microwave waveguide and source. The frequency of the microwave generator 51 and the dimensions of the cavity 60 may be selected to achieve a resonance between a mode of the plasma cavity 60 having a high Q factor and the microwave frequency of the microwave generator 51.

In another embodiment, the plasma such as a hydrogen plasma may be formed by the plasma generator such as the surfaguide plasma generator 61, and the plasma may be accelerated to form a plasma jet by a plasma jet source 50. In an embodiment, the plasma cavity 60 may comprise a thruster such as at least one of a Helicon, magnetohydrodynamic, electrostatic, or another thruster known in the art. The thruster may accelerate at least one charged species such as electrons or ions or a plasma such as a hydrogen plasma along the positive z-axis of the channel. In an exemplary embodiment, the thruster may accelerate an H₃⁺+e⁻ plasma beam along the positive z-axis of the channel.

The cavity 60 may connect to a plasma channel 10 that may further comprise magnets 53 such as permanent or electromagnets such as Helmholtz coils to at least one of magnetized, polarize, and provide confinement and axial flow of the free electrons of the plasma. In an exemplary embodiment, the Helmholtz coils comprise a magnetic bottle to provide confinement and axial flow of the free electrons of the plasma along the z-axis. The space drive may further comprise a (i) a plasma channel 10 connected to the plasma cavity 60 wherein at least one of electrons and plasma flow from the plasma cavity 60 to the plasma channel 10, (ii) a horn antenna 56, (iii) a microwave generator 73, and (iv) microwave power supply 58. The plasma channel 10 may further receive electromagnetic radiation such as microwaves from a source such as the horn antenna 56, microwave generator 73, and microwave power supply 58 to increase the free electron kinetic energy wherein the free electrons possessed an initial kinetic energy inventory in the direction of the molecular beam from the kinetic energy of the molecular beam. The plasma channel 10 may further comprise at least one RF or microwave reflector 20 on the opposite side of the plasma channel 10 from the horn antenna 56 to reflect RF or microwaves that are not absorbed by electrons back to the plasma channel 10 and horn antenna 56. The microwaves may be polarized in the plane of the electrons that may be aligned or polarized wherein the free electron alignment or polarization may be due to an applied magnetic field. The plasma channel 10 may further comprise a microwave waveguide to cause the microwaves from the source 73 and 56 to at least one of propagate in a desired direction and possess a desired polarization. In an embodiment wherein the direction of propagation of both the molecular beam and the free electron beam is defined as the z-axis (vertical in FIG. 1), the plane of the polarized electrons is the xy-plane with the electron angular momentum of ℏ along the transverse z-axis. The microwaves may propagate in at least one direction such as along the y-axis and transverse to the z-axis.

In an embodiment, an H₃⁺ beam may also be formed in cavity 60 from the molecular hydrogen beam, and the H₃⁺ beam may flow into the plasma channel 10. The electrons with increased kinetic energy from the incident microwave radiation from source 73 absorbed while propagating along the plasma channel 10 may drag the ions such as H₃⁺ ions.

The free electrons may propagate from cavity 60 through a drift channel 10 or plasma channel 10 to a force transducer anchored to a structural element that converts kinetic energy of the energized electrons to a force applied to the structural element such as the structure to which the transducer is anchored. Collectors such as Faraday cups and beam recirculators, and vacuum pumps may collect the electron beam and H₃⁺ beam collision products wherein the products may be recirculated.

The force of the energized electrons may be harnessed by at a series of conductive cavities or electrodes 70, 71, and 72 that receive the energized electrons to become charged to a voltage such as a high voltage such as one in the range of about 1 V to 100 MV. The voltage may provide a repulsive force against subsequent energized electrons of the beam reaching at least one repulsive cavity or electrode. Alternatively, the space drive may comprise a source of electrode voltage that may be applied to the electrodes to cause a repulsive force on the electrons to cause them to lose kinetic energy and transfer the energy to the at least one repulsive electrode. The repulsive force on the cavities or electrodes may be transduced to the cavities or electrodes and subsequently to a structure 62 to which they are anchored. The cavities or electrodes may be electrically insulated as in the case of a van der Graaf generator or Marx generator. To prevent arcing, the cavities or electrodes may be maintained in vacuum with separating electrical insulators 54 and 57 between member of a series of cavities or electrodes and from the structural support 62, respectively, wherein the drift or plasma channel 10 penetrates through the insulators. The series of cavities or electrodes may comprise right cylinders (e.g. 70 and 71), each with a large radius to accept high charge, and may further comprise at least one inverted right conical cavity 72 that receives energized electrons at the cone apex. The sloped walls of the conical cavity may partially transduce a force along one axis such as the electron beam axis to a transverse axis corresponding to a transverse force component. The space drive may comprise a means to tilt at least one cavity or electrode 70, 71, and 72. In an embodiment, the conical cavity 72 may be tilted from being aligned on the electron beam axis to develop at least one force component in the direction of the tilted beam axis and at least one component transverse to the tilted beam axis. In another embodiment, a means to brake at least one of the kinetic flow, kinetic and electrostatic momentum, kinetic energy, and pressure 72 comprises a rigid piston such as a closed cavity that may be diverging to increase the flow velocity by plasma expansion before being braked by the rigid piston.

In an embodiment, the space drive may further comprise magnets to apply a magnetic field. The magnetic field may be along an axis that is about perpendicular to the axis of propagation of the positive ions and the electrons. In an embodiment, positive ions and electrons may be separated by the magnetic field that causes an opposite Lorentz deflection of the positive ions and negative electrons.

In another embodiment, the repulsive field means may comprise at least two electrodes 70, 71, and 72 to provide a repulsive force on the electron beam or flow. The repulsive force on the electrons may be transduced to the electrodes and subsequently to the structure 62 to which the electrodes are anchored. One electrode may comprise a grid such as a metal mesh grid to allow electrons having kinetic energy to pass through the grid. The at least two electrodes may function in the opposite role as those of the Franck-Hertz experiment. In an embodiment shown in FIGS. 1A-1C, the space drive comprises the electron beam emitted by the electron gun 50, and the repulsive field means comprises (i) a cathode of the electron gun to emit the electron beam, (ii) a metal mesh grid electrode 70 with a positive bias to draw electrons towards it, and (iii) at least one negatively biased electrode 71 and 72 to provide a repulsive field to act on the electrons passing through the grid electrode 70. At least one of the electron-repelling electrodes 71 and 72 may comprise a metal mesh grid electrode. The ionized molecular beam may replace the electron beam emitted by the electron gun. Specifically, in an embodiment, the molecular beam may be ionized to form a beam or flow of at least electrons and optionally ions such as H₃⁺ ions, and the repulsive field means comprises (i) a metal mesh grid electrode or anode 70 with a positive bias to draw electrons towards it and (ii) at least one negatively biased electrode or cathode 71 and 72 to provide a repulsive field to act on the electrons passing through the grid electrode 70. In an embodiment, the positive ions of the corresponding flow of ions and electrons may be at least partially repelled by the positively biased electrode 70. The voltage-drop across the at least two electrodes may be controlled by a voltage and current sensor and a controller to optimize the kinetic energy power transferred to the repulsive field means Electron and ion currents may result in ion-electron recombination wherein the resulting gas may be recirculated to the molecular beam source 50 by a gas recirculation means.

The space drive may be oriented with the electron beam axis in the direction of the desired force. The space drive system may comprise a plurality of space drive units oriented along different axes to achieve drive in the corresponding selected directions. The space drive system may comprise a reorientation means to cause at least one space drive system to tilt in a selected direction to achieve drive in that direction. A plurality of space drives may be distributed among a plurality of locations of a craft. A representative distribution is at the apices of a triangular craft that has the feature of being an optimal design for transverse directional maneuverability of a triangular leading-edge airfoil design. Other desirable symmetrical geometries for craft are cylindrical, disc, and spherical. In an embodiment, a craft may be caused to spin by conservation of angular momentum of an orbiting electron beam that serves as the source of microwaves to be absorbed by the axial electron beam or electron flow. The craft may also be caused to spin by sequentially activating space drive units at different locations and orientations to cause it to wobble and then spin. The spinning motion may average out the forces of a plurality of units to achieve greater lift stability.

In another embodiment shown in FIGS. 1A-1C, the space drive comprises a plasma maintained by a plasma excitation system. The plasma excitation system may comprise a plasma tube or cavity 60, electrodes, and an electrode power supply such as a glow discharge plasma system. Alternatively, the plasma excitation system may comprise an electrode-less discharge system. Four exemplary distinct types of excitations for electrode-less discharges are (i) inductive (magnetic field) discharges, (ii) capacitive (electric field) discharges, (iii) microwave discharges, and (iv) travelling wave discharges each comprising system known in the art. In an exemplary embodiment of the capacitive discharges, a surface wave is propagated along the plasma column using a capacitive coupling, in which there is an intense field between the ground plane and a copper ring placed around the tube. In another exemplary embodiment, the surfaguide is a device that can be used as a plasma source that comprises a simple surface-wave launcher in which a waveguide device can propagate a surface wave along the tube for plasma discharge. The main advantages of surfaguide with respect to other plasma sources are the possibility of using the GHz frequencies such as a frequency of 2.45 GHz wherein at this frequency, high power is available at low cost. In a further exemplary embodiment, the space drive system comprises at least one of an RF generator 50 with matching network 15, a gyrotron 50, and a surfaguide or surfawave launcher 50 to supply electromagnetic power to gas in the cavity 60 to maintain a plasma such as a H₂ plasma in the cavity. The plasma cavity may comprise a tube such a quartz tube 60 that may be inserted through the waveguide 61. The cavity 60 may comprise a plasma generator such as a surfaguide plasma generator that may comprise an RF or microwave generator 50, a waveguide 61, and a matching network 15 to match the impedance of the load and the plasma cavity to the microwave waveguide 61 and source 50.

In an embodiment, the space drive system may comprise at least one electromagnetic power generator 50 to output electromagnetic radiation such as at least one of a radio wave and microwave generator. The radio waves may comprise electromagnetic radiation with wavelengths in the electromagnetic spectrum longer than infrared light. The microwaves may comprise electromagnetic radiation with wavelengths ranging from about one meter to one millimeter corresponding to frequencies between 300 MHz and 300 GHz, respectively. The radio wave generator may further comprise a matching network 15. The matching network 15 may output to a transmission line 61 or a radio wave or microwave guide or cavity 61. The guide or cavity 61 may provide electromagnetic power to at least one of maintain a plasma such as a hydrogen plasma and excite linear translation of free electrons. The electromagnetic power may comprise photons that may be absorbed by free electrons to increase the free electron kinetic energy. The waveguide or cavity 61 may comprise a multi-modal cavity such as a bimodal waveguide or cavity. The waveguide or cavity 61 may comprise a section with smaller dimensions such as a smaller channel height than at least one other section that may serve to intensify the radio or microwave power density. The waveguide may comprise a penetrating plasma tube 60 that is at least partially transparent to the radio or microwave wave maintained in the waveguide or cavity. Free electrons or a source of fee electrons may be flowed in the plasma tube. Source of free electrons may comprise hydrogen gas. The space drive system may comprise a source of gas such as hydrogen gas, flow meters, regulators, valves, a vacuum pump, pressure gauges and controller, and other systems to supply a flow of plasma gas under a desired set of pressure and flow conditions such as a flow rate between 1 ml to 1000 liters per second and pressure in the range of 1 micro-Torr to 760,000 Torr.

The plasma cavity or tube 60 may have a connection to a plasma channel 10 along the positive z-axis. The plasma channel 10 may comprise a source of a magnetic field such as an axial field. The source may comprise a source of axial magnetic field such as Helmholtz coils 53 through which the plasma channel 10 may pass such as through the center of the coils. The axial magnetic field may comprise a pinch at one or more regions such as at the position of at least one Helmholtz coil 53. The source of magnetic field may further comprise a magnetic bottle wherein the highest energy electrons and ions pass in the z-axis direction.

The space drive may comprise a second electromagnetic power generator 73 to output electromagnetic radiation such as at least one of a radio wave and microwave generator. The radio waves may comprise electromagnetic radiation with wavelengths in the electromagnetic spectrum longer than infrared light. The microwaves may comprise electromagnetic radiation with wavelengths ranging from about one meter to one millimeter corresponding to frequencies between 300 MHz and 300 GHz, respectively. The radio wave or microwave generator may further comprise a matching network 74. The radio wave or microwave generator 73 or matching network 74 may output to a transmission line or a radio wave or microwave guide or cavity, or an antenna 56. The antenna such as a horn or strip antenna 56 may output at least one of directional and polarized radiation and radio wave or microwave photons. The plasma channel 10 may comprise a material at least partially transparent to the incident EM radiation such a microwave. In an exemplary embodiment, the channel may comprise quartz or a ceramic such as one of the disclosure. The plasma in the plasma channel 10 may be incident and absorb radio wave power as RF or microwave photons from the second radio wave or microwave generator 73. An exemplary microwave frequency is in the range of 1 to 10 GHz. Microwave generator may comprise a magnetron, klystron, traveling-wave-tube (TWT), gyrotron, a solid state high power microwave source (https://rfhic.com/driving-microwave-energy-with-gallium-nitride-solid-state-technology/), and others known in the art. The antenna 56 may emit a directional beam of photons that are incident the plasma channel in a transverse direction such as along the x-axis in the case of a z-axis orient plasma channel. The space drive may comprise at least one reflector such as a radio wave or microwave reflector 20. Photons not absorbed by the transverse-oriented horn antenna may propagate to an opposing corner reflector 20 such as a dihedral or trihedral one. The reflector may reflect the photons back to the plasma channel 10 to be at least partially absorbed by electrons. The unabsorbed photons may propagate to the antenna 56 to be reflected to the channel to repeat a round trip reflection-absorption cycle between the antenna-plasma-channel-reflector. In an embodiment, the antenna such as the horn antenna 56 and reflector 20 such as dihedral or trihedral one may irradiate a substantial longitudinal portion of the drift or plasma channel 10 such as 30% to 100%.

The radio frequency photon absorption by the electrons may cause the electrons to accelerate, and H₃⁺ ions may be dragged with the accelerated electrons to a diverging nozzle and repeller electrode that transfers electron and ion kinetic energy to a thrust converter such as the repeller electrode or brake 72. The corresponding thrust may be transferred to a craft rigidly attached to the thrust converter. With the kinetic energy transfer, electrons and the H₃⁺ ions dragged with the accelerated electrons may recombine and the resulting H₂ gas may be recirculated to the plasma cavity 60.

The plasma cavity 60 may comprise any desired geometrical shape such as a right cylinder, sphere, polygon such as a rectangle, square or pyramidal cavity such as an equilateral pyramidal cavity comprising a plasma outlet at least one of the four equivalent apexes. The plasma cavity comprises a material that is transparent to at least one of radio and microwaves such as quartz, sapphire, MgF₂, glass, fused silica, alumina, zirconia, hafnia, magnesia, boron nitride, and other ceramics and radio and microwave transparent materials known in the art.

In an embodiment, the plasma excitation system to maintain plasma in cavity 60 may comprise a thruster such as at least one of a Helicon, magnetohydrodynamic, electrostatic, or another thruster known in the art to accelerate an H₃⁺+e⁻ plasma beam. The planar geometry of the free electron and H₃⁺ may stabilize the corresponding ion pair to increase the free electron lifetime and increase the microwave photon absorption cross section.

The second electromagnetic power generator comprising a gyrotron 73 may produce microwave output at a frequency resonant with the magnetic field applied to the plasma of the plasma channel 10 such as an axial field such as a Helmholtz coil (53)-applied axial magnetic field. The magnetic bottle may be replaced by a thruster such as at least one of a Helicon, magnetohydrodynamic, electrostatic, or another thruster known in the art to accelerate an H₃⁺+e⁻ plasma beam along the positive z-axis of the channel.

In an embodiment, the plasma channel 10 is connected at an angle relative to the plasma chamber 60 to avoid inference or coupling of the radio waves or microwaves of the first electromagnetic radiation generator 50 and those of the second electromagnetic radiation generator 73 wherein the interference or coupling deceases the kinetic energy power of the plasma flow at the repeller or brake 72. In an embodiment, the connection between the plasma cavity 60 and the plasma channel 10 may be angled to provide better packaging of the assembly comprising at least one of the plasma cavity 60, plasma channel 10, and RF generator 50 with matching network 15. The wave guide, transmission line, or cavity 61 may be slanted to support a resonant electromagnetic cavity mode that is matched with the non-colinear plasma tube to plasma channel connection.

In an embodiment, the plasma channel 10 may comprise at least one of electrical breaks 54 and transverse plasma expansion chambers or cavities 70,71 to prevent at least one of cavity mode formation and collisional degradation of the increase in kinetic energy due to power absorbed from the horn antenna 56.

The photons emitted by the antenna 56 of the second electromagnetic power generator 73 such as the horn antenna of a microwave generator may comprise linear polarized photons. Each photon may have its electric field in the xy-plane. Alternatively, the incident photon may comprise a circular polarized photon. The polarization may be in the xy-plane.

The RF or microwave reflector 20 comprising a main reflector such as a corner reflector opposed to the transversely-oriented horn antenna such as a dihedral or trihedral one may further comprise a series of trihedral reflectors for side lobes azimuthally positioned with the main reflector at the center corresponding to the RF side lobes and main lobe respectively. The corner reflector is a passive device used to directly reflect radio waves back toward the emission source. In general, the corner reflector consists of mutually intersected perpendicular plates. Exemplary corner reflectors are dihedral and trihedral. While the dihedral corner reflector is sensitive to its mechanical alignment, the trihedral corner reflect is highly tolerant to misalignment. An exemplary trihedral corner reflector comprises three right angle plates.

In an embodiment, comprising a hydrogen plasma, the free electrons may be formed in a zero-E-field electronic energy state that is at zero energy with respect to the electric field of the positive electric field of a positive ion of an electron-ion pair. The positive ion may comprise H₃⁺ wherein the electron is excited to a position equal distance between two protons of H₃⁺ along the corresponding internuclear axis. The electron may be excited by a photon source resonant for excitation to this state. The electron in an electric-field-free energy state has zero gravitational mass. The population of the zero-E-field electronic energy state may increase the cross section for absorption of photons to achieve higher kinetic energy states with violation of linear momentum conservation while conserving the energy of the photon and the inertial mass energy of the electron including its increased kinetic energy. The electron kinetic energy may be at least partially transferred to the partner positive ion of the electron-ion pair such as H₃⁺ that it “drags” in an electron-H₃⁺ plasma wherein the corresponding driven plasma flow is transduced to provide drive. Since H₃⁺ comprises ortho and para nuclear spin states and a free electron has a spin of ½, the cross section for the absorption of a photon by the free electron may be increased by coupling between the free electron spin and nuclear spins of a free-electron/H₃⁺ ion pair based on the section rules for such transitions.

1. A propulsion system providing at least one of propulsion and lift, comprising
a source of a molecular beam or jet,
a plasma generator coupled to the source,
a first plasma chamber coupled to the source and to the plasma generator to maintain a hydrogen plasma comprising free electrons and H₃⁺ ions,
a first plasma channel for the flow of the hydrogen plasma from the first plasma chamber,
a microwave generator,
a horn antenna to irradiate the plasma flow with microwaves from the microwave generator, and
a negatively charged, repulsive electrode to repel received electrons that have absorbed microwaves in a directional manner and gained reactionless kinetic energy in a directional manner.

2. The propulsion system of claim 1, further comprising
a radio frequency generator,
a matching network,
a second plasma chamber powered by the radio frequency generator,
a second plasma channel for the flow of the plasma from the second plasma chamber comprising a magnetic bottle,
a microwave generator
a horn antenna to irradiate the plasma flow with microwaves from the microwave generator,
at least one microwave reflector opposed to the horn antenna, and
a closed divergent cavity to brake plasma flow maintained by electrons that have absorbed microwaves in a directional manner and gained reactionless kinetic energy in a directional manner.

3. The propulsion system of claim 2, further comprising
at least one structural element attached to the repulsive electrode wherein the kinetic energy of the electrons is transferred to the repulsive electrode to produce a propulsion force on the at least one structural element supporting the electrode.

4. The propulsion force of claim 3, further comprising a plurality of space drive units oriented along different axes to achieve the at least one of propulsion and lift in the corresponding selected direction.

5. The propulsion system of claim 4, further comprising a reorientation means to cause at least one space drive system to tilt in a selected direction to achieve the at least one of propulsion and lift in that direction.
